(19) United States
(12) Patent Application Publication
(10) Pub. No.: US 2019/0274469 A1
(43) Pub. Date: Sep. 12, 2019

(54) SYSTEM AND DISPOSABLE CARTRIDGE FOR THE PREPARATION OF A LIQUID PRODUCT

(71) Applicant: APIQE HOLDINGS, LLC., Torrance, CA (US)

(72) Inventor: Jasper Jacobus van de SLUIS, Utrecht (NL)

(73) Assignee: Apiqe Holdings, LLC, Torrance, CA (US)

(21) Appl. No.: 16/302,445

(22) PCT Filed: May 17, 2017
(86) PCT No.: PCT/NL2017/050312

§ 371 Date: Nov. 16, 2018

(30) Foreign Application Priority Data
May 17, 2016 (NL) 2016790

(51) Int. Cl. A47J 31/40; B65D 85/804; B67D 1/00

(52) U.S. Cl. CPC A47J 31/407; B67D 1/0078; B65D 85/804

(57) ABSTRACT

The invention relates to a system, for the preparation of a liquid product, comprising a disposable cartridge (1) and a dispensing apparatus. The cartridge comprises a cartridge body (2) having a reservoir (5), one or more dispensing passages located at its bottom and a sealing film (12) that seals off the reservoir at the top of the cartridge. The cartridge further comprises piercing members (14) arranged in the reservoir so that pressing the sealing film inward causes said piercing members to locally rupture the sealing film. According to the invention, the cartridge has a droplet capture member, adjacent the sealing film and in the vicinity of the piercing members, such that when the sealing film has been ruptured the droplet capture member extends over the one or more openings in the sealing film to capture droplets of liquid ingredient exiting said openings.

The present invention relates to a system and to a disposable cartridge filled with a single serve portion of a liquid ingredient to be combined with a base liquid for the preparation of a liquid product, e.g. a liquid food product suitable for human consumption, e.g. a beverage concentrate to be combined with water, e.g. carbonated water, for the preparation of a beverage.

It is an object of the invention to provide an improved system and/or disposable cartridge. The invention covers multiple aspects which in isolation provide an improved system and/or disposable cartridge, but which can also combined.

According to a first aspect, the invention provides a system and a sealed disposable cartridge filled with a single serve portion of a liquid ingredient to be combined with a base liquid for the preparation of a liquid product.

Sealed cartridges holding liquid ingredient to be combined with a base liquid for the preparation of a liquid product, e.g. a liquid food product suitable for human consumption, e.g. a beverage, are known.

It has been found that a problem may occur with these sealed cartridges when they are opened, in particular when the sealed cartridges are opened by rupture of the seal film. Rupture of the seal may cause droplets of liquid ingredient to be propelled from the cartridge and/or seal. These droplets may contact parts of the dispensing device with which the cartridges are used. This may require cleaning of those parts, which is unwanted.

According to the first aspect, the invention provides a system for the preparation of a liquid product, e.g. a liquid food product, e.g. a beverage, which system comprises:

a) a disposable cartridge filled with a single serve portion of a liquid ingredient to be combined with a base liquid for the preparation of a liquid product, e.g. a beverage concentrate to be combined with water, e.g. carbonated water, for the preparation of a beverage, the disposable cartridge comprising:
a cartridge body with a bottom and a top, the body delimiting a reservoir that is filled with a single serve portion of a liquid ingredient,

wherein the cartridge body has an aperture at its top, which aperture is in communication with said reservoir, and has one or more dispensing passages located at its bottom, which one or more dispensing passages are arranged to dispense the liquid ingredient from the reservoir;
a sealing film, e.g. a top sealing film, said sealing film having a portion that covers said aperture, which sealing film is sealed to the cartridge such that the reservoir of the cartridge body is hermetically sealed by said sealing film; and
one or more piercing members that are arranged underneath the portion of the sealing film that covers the aperture, so that pressing the sealing film, or at least a part thereof, inward, e.g. downward, causes said one or more piercing members to engage the sealing film and locally rupture the sealing film, thereby providing one or more openings that allow introduction of gas into the reservoir in order to assist dispensing of said liquid ingredient;

b) a dispensing apparatus, e.g. a beverage dispensing apparatus, the apparatus comprising:
a holder adapted to accommodate and retain the disposable cartridge at a dispensing location in the apparatus,
a base liquid feed assembly with a base liquid feed member, e.g. a lance, disposed at the dispensing location, which base liquid feed member is embodied to provide base liquid to be mixed with the liquid ingredient,
a push member, configured to engage the sealing film, preferably a central area of the sealing film, of the disposable cartridge accommodated in the dispensing location, and to push a portion of said sealing film into the reservoir to rupture the sealing film by means of the one or more piercing members and thus create the one or more openings in the sealing film,
an operable displacement device which is adapted to produce a movement of the holder for the cartridge and the push member relative to each other, so that when the displacement device is operated the push member pushes the sealing film into the reservoir, ruptures the sealing film and thus create the one or more openings in the sealing film.

According to the first aspect of the invention, the cartridge is furthermore provided with a droplet capture member, which droplet capture member is located adjacent the sealing film and in the vicinity of the piercing members such that after the sealing film has been ruptured the droplet capture member extends over the one or more openings in the sealing film to capture droplets of liquid ingredient exiting said openings while allowing said introduction of gas into the reservoir via said openings.

Thus, the invention provides a system and a cartridge which reduce the chance of contamination of the dispensing device by droplets of liquid ingredient.

In an embodiment, the droplet capture member is located adjacent the sealing film on the inside of the reservoir, i.e. adjacent the side of the sealing film facing the reservoir, and moves with the sealing film when the latter is pushed into the reservoir. In such an embodiment, the sealing film protects the droplet capture member from the environment, at least until the sealing film is pierced.

Thus the droplet capture member can be made of delicate material, for example a thin foil, and/or be of a delicate design, for example be provided with multiple openings, without the risk of the droplet capture member getting damaged, contaminated or inoperable prior to use, e.g. due to the droplet capture member being tom or stained, during transport or storage of the cartridge or when placing the cartridge in the dispensing device.

In an embodiment, the droplet capture member is located adjacent the sealing film on the outside of the reservoir, i.e. adjacent the side of the sealing film facing away from the reservoir. Thus, prior to the sealing film being ruptured, the droplet capture member is shielded from the liquid ingredient. When located on the inside of the seal, the capture member may get soaked by liquid ingredient, or liquid ingredient may get between the droplet capture member and the sealing film, which in turn may promote liquid ingredient escaping form the reservoir when the sealing film, located adjacent the droplet capture member, is ruptured. This risk is avoided with providing the droplet capture member on the outside of the sealing film.

In addition, a droplet capture member located on the outside of the reservoir may be provided with protective means, for example in the form of an additional tear away seal or removable lid, or in the form of a coating, to prevent damage or contamination of the droplet capture member prior to use, i.e. during transport, storage, etc. Such protective means preferably are adapted to be removed prior to use, i.e. prior to rupture of the sealing film.

In an embodiment, the invention provides a cartridge with a droplet capture member on the inside and with a droplet capture member on the outside of the sealing film.

In an embodiment, the droplet capture member is a film seal, e.g. a seal made of a flexible foil sheet material. It is noted that the droplet capture member does not need to hermitically seal the reservoir of the cartridge, as this is the function of the film seal. Therefore, the droplet capture member can be made of a material that is for example more flexible and/or more elastic. Furthermore, it can be a single layer material since no barrier properties are required. As an alternative, a multi-layer material can be used, for example a flexible, resilient material sandwiched between layers of hydrophobe material.

In an embodiment, the droplet capture member is adapted to rupture when pierced by the piercing members. This can be achieved by providing a sealing film having a limited flexibility and/or by providing the sealing film with score lines or other local attenuation of the film seal.

In an embodiment, the droplet capture member is provided with local reinforcements that prevent significant rupture of the droplet capture member when pierced by the one or more piercing members, to thus ensure that the one or more piercing only create small openings, which small openings reduce the chance of any droplets of liquid ingredient passing through them. For example, the droplet capture member may comprise a thin flexible carrier film, provided with ring shaped reinforcements located such that each encircles an area to be pierced by a piercing member.

In an embodiment, the droplet capture member is provided adjacent the inside surface of the sealing film, and is provided with one or more openings for receiving at least a tip of the one or more piercing members, such that, when the sealing film is pushed into the reservoir, the one or more piercing members do not pierce the droplet capture member but only stretch and/or rupture the droplet capture member. Thus, in such an embodiment, the droplet capture member may be configured to closely fit the cross section of the piercing members. For example, when the piercing members are provided with a circular, oval or rectangular cross section, the droplet capture member can be a flexible film seal provided with circular, oval or rectangular openings for receiving the piercing members.

In an embodiment, the droplet capture member is provided in the form of a foil provided with openings having a shaped and size the fits the cross section of the one or more piercing members, e.g. the piercing members have an L-shaped, C-shaped or S shaped cross section, and the droplet capture member is provided with openings having a similar shape, preferably match the cross section of the piercing members.

In an embodiment, the openings in the droplet capture member are dimensioned such that they are cut or tom while the piercing member passes through the openings in the droplet capture member. This may be achieved by providing the openings with a cross section that does not fit the cross section of the piercing member, for example is substantially smaller than the cross section of the piercing member. Preferably, the cuts or ruptures provide the droplet capture member with one or more flaps that rest against the piercing member, and thus at least partially cover the opening in the sealing film located adjacent the droplet capture member. In an embodiment, the piercing members are provided with sharp or jagged edges to promote them cutting into the droplet capture member.

In an embodiment, the openings in foil are dimensioned such that they tightly fit the piercing members, such that the piercing members stretch the foil when passing through the openings, to thus provide tight fit of the droplet capture member around the piercing members. In such an embodiment, the droplet capture member is preferably provided with additional openings, located away from the piercing members such that they do not overlap with any of the openings in the film seal, for facilitating gas to enter the reservoir.

In an alternative embodiment, the droplet capture member is provided with one or more openings for receiving the one or more piercing members, which openings are dimensioned such that, when the sealing film is pushed into the reservoir, the one or more piercing members do not pierce and/or rupture the droplet capture member. In such an embodiment, the openings are preferably dimensioned such that they tightly fit the piercing members when the droplet capture member has been pushed into the reservoir of the cartridge.

In an embodiment, the droplet capture member is adapted be pierced, but to tear only locally when pierced by the piercing members, such that the droplet capture member substantially covers the one or more openings ruptured in the top seal by the piercing members when the sealing film is pressed into the reservoir. Such a droplet capture member can be embodied in a film without any pre cut openings but with ring shaped reinforcements encircling the area to be pierced by a piercing member.

In an embodiment, the droplet capture member is highly elastic compared to the sealing film, such that when the sealing film is pushed into the reservoir, the droplet capture member is stretched when engaged by the one or more piercing members, and is ruptured by the one or more piercing embers only after the sealing film has been ruptured. In a preferred embodiment, the droplet capture member is not resilient, or at least no fully resilient, such that it is stretched during the piercing and forms a mantle around part of the piercing member. In such an embodiment, the piercing members preferably are provided with a curved or corrugated cross section, i.e. a C-shaped or X-shaped cross section, such that the shrouds of droplet capture member create one or more longitudinal channels along the piercing member.

In this context it is mentioned that the droplet piercing member, in particular when made of a thin flexible foil material, when provided with pre-cut openings or even when pierced may fit the piercing members tight enough to prevent droplets of liquid from escaping the reservoir, but not tight enough to prevent gas from escaping the reservoir.

In an embodiment the droplet capture member is highly elastic compared to the sealing film, such that when the sealing film is pushed into the reservoir, the droplet capture member is only stretched and is not ruptured, and wherein the droplet capture member is provided with one or more openings, not being pores, for letting through gas, which openings are located away from the piercing member such that the they do not overlap with the openings in the sealing film. Thus, in such an embodiment the droplet capture member is stretched over the piercing members, more or less like a tent. When the droplet capture member is located at the inside surface of the sealing film, part of the droplet capture member will pass through the sealing film with the piercing members piercing set sealing film. Thus, the tops of the one or more piercing members will extend through the openings in the sealing film and will be covered by the stretched sections of the droplet capture member.

In an embodiment the droplet capture member is provided with multiple pores, which pores are dimensioned such that they allow gas to pass the droplet capture member, even when the droplet capture member is not ruptured, but obstruct droplets of liquid ingredient from passing the droplet capture member.

In such an embodiment the droplet capture member comprises a microporous membrane that allows gas to pass while blocking the passage of liquid ingredient. In such an embodiment, the membrane's micropores are large enough to allow gas molecules to pass, but are smaller than droplets of liquid product. Search a microporous membrane may comprise more than one billion micropores per cm2. Each one of these micropores is 20,000 times smaller than a drop of water, so water molecules are too large to pass the membrane. However, when the micropores are also 700 times larger than air molecules gas can easily pass through the membrane and into the reservoir of the cartridge.

In an embodiment a portion of the droplet capture member covering the reservoir is provided with one or more premade score lines, e.g. by laser machining, which are embodied such that pressing the sealing film into the reservoir causes said one or more premade score lines to rupture thereby providing one or more openings that allow gas to pass the droplet capture member into the reservoir.

In an embodiment, the droplet capture member is highly elastic compared to the sealing film, such that when the sealing film is pushed into the reservoir, the droplet capture member is only stretched and is not ruptured, and wherein the droplet capture member is provided with multiple pores, which pores are dimensioned such that they allow gas to pass the droplet capture member but obstruct droplets of liquid ingredient from passing the droplet capture member. In addition to the pores, the sealing film can be provided with one or more openings for letting through gas, as discussed above, which openings are located away from the piercing member such that they do not overlap with the openings in the sealing film.

In an embodiment, the droplet capture member is a film type seal provided with premade score lines, which premade score lines are located away from the area that covers the piercing members, such that, when the sealing film is pushed into the reservoir, the rapture of the score lines creates openings in the droplet capture member that do not overlap with the openings in the sealing film.

It is submitted that when the sealing film has been pierced typically a gap has been created between the droplet capture member and the sealing film. Such a gap is wide enough to allow gas to travel between the droplet capture member and the sealing film, and thus to travel through said gap from an opening in the sealing film to an opening in the droplet capture member. However, such a gap is narrow enough to slow down and even stop droplets of liquid product Since the openings in the droplet capture member and the sealing film do not overlap, a droplet of liquid products has to pass the gap between the droplet capture member and the sealing film to reach an opening in the sealing film. Thus, providing a pre scoured film type droplet capture member at the inside surface of the sealing film prevents droplets of liquid product to be propelled from the reservoir of the cartridge and out of an opening in the sealing film when set sealing film is pierced by the piercing members.

In an embodiment, a portion of the sealing film covering the reservoir is provided with one or more premade score lines, e.g. by laser machining, which are embodied such that pressing the sealing film into the reservoir causes said one or more premade score lines to rupture thereby providing one or more openings that allow gas to pass the droplet capture member into the reservoir, and wherein

a portion of the droplet capture member covering the reservoir is provided with one or more premade score lines, e.g. by laser machining, which are embodied such that pressing the sealing film into the reservoir causes said one or more premade score lines to rupture thereby providing one or more openings that allow gas to pass the droplet capture member into the reservoir, and wherein

the score lines in the sealing film cross the score lines in the droplet capture member, such that rupture of the score lines creates one or more openings in the sealing film and in the droplet capture member, which respective openings only partially overlap.

For example, in an embodiment the droplet capture member may be provided with a premade score line which extends perpendicular to and crosses a premade score line provided in the sealing film, the combination of premade score lines forming an X with the centre of the cross located above the piercing member. Thus, when the sealing film is pushed into the reservoir both premade score lines will rupture creating two slid-shaped openings, one crossing the other. These openings will enable gas to travel from outside the cartridge into the reservoir while hampering a droplet of liquid product, propelled from inside the reservoir due to the rupture of the droplet capture member and or the sealing film, to escape said reservoir via said openings.

In an embodiment, the droplet capture member is provided with one or more local perforation zones, each perforation zone comprising multiple perforations, which one or more local perforations zones are located in areas above the one or more piercing members to reduce rupture length in the droplet capture member when the sealing film is pushed into the reservoir.

In an embodiment, the droplet capture member is adapted to be cut by the piercing members, and not rupture, such that the piercing members do not create openings that extend substantially beyond the cross section of the piercing members. It is submitted that cutting the droplet capture member allows for a more precise control over the size of the opening created by the piercing member compared to rupture of the droplet capture member. An alternative that also provides more controlled creation of openings, compared to rupture, is providing the droplet capture member and/or the sealing film with premade score lines.

In an embodiment according to the invention, the droplet capture member is located adjacent the sealing film on the outside of the reservoir, i.e. adjacent the side of the sealing film facing away from the reservoir, and is provided with an opening, which opening is dimensioned and located for the push device to pass through, enabling the push device to push down the sealing film, located below the droplet capture member, without pushing down the droplet capture member, such that the droplet capture member does not contact the piercing members and is not ruptured when the sealing film is pushed into the reservoir. After the sealing film has been ruptured, the intact droplet capture member overlaps with the one or more openings created in the sealing film after it has been pierced.

Such embodiment allows for a simple droplet capture member, since there is no need to provide the droplet capture member with multiple pre-cut openings, pores, and/or premade score lines. Furthermore, the droplet capture member is not contacted by the piercing members when piercing the sealing film, and the droplet capture member will not be transformed during the piercing process. Thus in such an embodiment the droplet capture member can be provided in the form of a donut shaped disc made of foam material, plastic sheet material or even cardboard.

An additional benefit of this embodiment is that the droplet capture member covers the tops of the piercing members after the sealing film has been pierced. Thus, when the cartridge is removed from the dispensing device, it shields the tops of the piercing members and prevents accidental contact between those piercing members and the user removing the cartridge.

An additional benefit of this embodiment is that the droplet capture member covers the tops of the piercing members after the sealing film has been pierced. Thus, when the cartridge is removed from the dispensing device, it shields the tops of the piercing members and prevents accidental contact between those piercing members and the user removing the cartridge.

Furthermore, such a droplet capture member allows for the droplet capture member to be made of a more rigid material, compared to a droplet capture member configured for example to stretch over the piercing members.

In an embodiment, the droplet capture member has a stiffness such that it substantially holds its shape when the sealing film is pushed into the reservoir, and the sealing film is thus at least partially pushed away from the droplet capture member, creating a passage between the sealing film and the droplet capture member, when the sealing film is pushed into the reservoir.

Thus, such a droplet member can also be used to prevent the top sealing film from being pushed into the reservoir by accident, for example when the cartridge is inserted in the dispensing device, during transport or storage, or when the cartridges are stacked one on top of the other. This is in particular the case when the droplet capture member has some structural rigidity, for example is made of a cardboard or foam material having a certain thickness, for example a foam material having a thickness of 1 mm.

In an alternative embodiment, the droplet capture member is part of the sealing film, more in particular in combination with the sealing film hermetically seals the aperture of the cartridge. In such an embodiment, the droplet capture member is located on top of the sealing film, and the sealing film is at least partially sealed to the bottom side of the of the droplet capture member such that when the push member pushes the sealing film into the reservoir it at least partially tears away from the droplet capture member. In a preferred embodiment, the sealing film is provided with pre-cut openings, i.e. openings for enabling gas to flow into the reservoir, in the part of the sealing film that is torn away from the droplet capture member, such that the openings are opened by the pushing action of the pushing member. Thus, when the sealing film is pushed into the reservoir, the openings first effectively sealed by the droplet capture member are opened. In such an embodiment the cartridge can be free of piercing members.

In a further alternative embodiment, the sealing film, or at least parts thereof are sealed to the droplet catching member such that, when the pushing member pushes the sealing film into the reservoir and away from the droplet catching member, it partially ruptures, the ruptures creating the openings for the gas to travel into the reservoir. To promote the tearing of the sealing film, it may be provided with pre made score lines.

In such alternative embodiments, the droplet capture member is preferably made of a ridged material, such that the droplet capture member does not move with the sealing film, or at least not significantly moves with the sealing film, into the reservoir when the sealing film is pushed downward by the pushing member, and to thus allow the sealing film to tear away from the droplet capture member, causing the sealing film to rupture and/or pre-cut openings in the sealing film to be opened.

In an embodiment, the droplet capture member is made of a cardboard, or of foam material. Furthermore, when the droplet capture member is provided on top of the sealing film it can be used as a carrier for print, for example graphics, and can thus be used as a label. Thus, standard cartridges can be provided with a label, located on top of the sealing film, which label also functions as the droplet capture member. Integrating label and droplet catcher member in a single product allows for a simplified production process.

In an embodiment, the sealing film and the droplet capture member are part of a single, multi-layer sealing film, which sealing film is applied to the cartridge body in a single production step during the production process. In an alternative embodiment, the droplet capture member is attached to the cartridge, or to the sealing form on top of the cartridge, after the reservoir has been sealed with the sealing film.

In an embodiment, the cartridge has a circumferential wall with an upper end, e.g. embodied with an outwardly protruding flange, said upper end bounding said aperture closed by the sealing film, and wherein the sealing film is sealed to said flange. In an embodiment, the droplet capture member is located on the inside of the sealing film, and both droplet capture member and sealing film are sealed to the flange during the production process of the cartridge. In an alternative embodiment, the droplet capture member is provided on the inside surface of the sealing film, and is sealed onto the flange while the sealing film is sealed onto the droplet capture member sealed on the flange. Alternative solutions for attaching sealing film and droplet capture member to the cartridge can also be used.

In an embodiment of the system, the base liquid feed member is embodied to connect to a channel of the cartridge, so that base liquid can be fed into the channel.

In a further embodiment, the channel is located in the centre of the reservoir. In a preferred embodiment, the cartridge is configured such that the channel, or at least the top end thereof can be pushed downward. In such an embodiment push member is preferably configured to engage the top end of the channel, and push both the sealing film and the top end of the channel downward, i.e. into the reservoir. In such an embodiment, the sealing film and/or the droplet catcher member are preferably sealed to the cartridge around the aperture and to the top end of the column, around the inlet of the channel. In an embodiment, the sealing film and/or the droplet capture member cover the aperture, but not the inlet of the channel. In such an embodiment, the sealing film and/or droplet capture member have a central opening, and may have a donut shape. In an alternative embodiment, the sealing film and/or the droplet capture member cover the aperture in communication with the reservoir and the inlet of the channel. In such an embodiment the push member is preferably configured for perforating, cutting or otherwise removing the section, or at least part thereof, of the sealing film and/or droplet capture member that covers the inlet opening of the channel.

In an embodiment, the base liquid feed ember is the push member, so that when the displacement device is operated the base liquid feed member connects to the channel.

In an embodiment, the cartridge body comprises a column which has a portion that projects upwards from the bottom, wherein the channel extends through the column from an inlet of the channel at a top end of the column, e.g. said top end being sealed to said sealing film and/or to said droplet capture member, to a dispensing aperture at the side of the bottom of the cartridge, wherein the base liquid feed member is adapted to connect to said inlet of the channel so that base liquid fed into the channel travels through the channel and exits the channel via the dispensing aperture.

In a further embodiment, the base liquid feed member is arranged within the contour of the of the peripheral gas seal and is adapted to sealingly engage the channel, e.g. the top end of the column, so as to act as gas seal, e.g. provided with a gas seal member, that prevents entry of pressurized gas into the channel.

In an embodiment, the dispensing apparatus further comprises a pressurized gas source, preferably a pressurized air source, e.g. an air pump, and wherein the apparatus is adapted to bring said pressurized gas source in direct communication with the reservoir of the disposable cartridge via one or more openings in the sealing film, so as to allow said liquid ingredient therein to be pressurized by said gas thereby assisting the dispensing thereof from the reservoir via said one or more dispensing passages.

In an embodiment, the dispensing apparatus further comprises a pressurization dome member having a peripheral gas seal, e.g. along a periphery thereof an outer gas seal, which is adapted to sealingly engage the disposable cartridge around a location where said one or more openings are created in said sealing film to allow entry of said pressurized gas into the reservoir, and the pressurized gas source is connected to said dome member and is adapted to feed pressurized gas beneath said dome member within the contour of the peripheral gas seal sealingly engaging the disposable cartridge, so as to allow said liquid ingredient in said reservoir to be pressurized by said gas via the one or more openings in said sealing film, thereby assisting the dispensing of the liquid ingredient from the reservoir via said one or more dispensing passages.

In a further embodiment, the base liquid feed member is a base liquid feed lance which protrudes from the pressurization dome member, preferably within the contour of the of the peripheral gas seal.

In a further embodiment, the peripheral gas seal of the dome member is a lip seal member having an inwardly directed resilient lip portion engaging the sealing film and/or droplet capture member, if located on top of the sealing film, preferably at or near the contour of the aperture in the cartridge body, said inwardly directed resilient lip portion being exposed to said pressurized gas so as to aid in the sealing engagement with the cartridge.

In an embodiment, the cartridge has a circumferential wall with an upper end, e.g. embodied with an outwardly protruding flange, said upper end bounding said aperture closed by the sealing film, and wherein the peripheral gas seal of the dome member is embodied to seal onto said upper end.

Furthermore, in addition to, or instead of, providing a droplet capture member, the chance of liquid ingredient escaping the reservoir via one or more openings pierced in the sealing film can also be reduced by providing a slight over presser, for example a pressure between 1,05 and 1,2 bar, for example 1,1 bar, to enable the gas to push the contents of the cartridge out of the cartridge. On the outside of the sealing film prior to piercing it. In an embodiment, a pressure dome is placed over the cartridge, to provide an overpressure to promote the liquid product ingredient to flow via discharge openings from the reservoir. The pressure dome may be provided with a flexible seal for engaging the top of the cartridge, which seal is to compressed by pressing the down the dome onto the cartridge, to provide a leak free connection between dome and cartridge. In such an embodiment, by providing a flexible seal of sufficient thickness, the pressing down of the dome onto the cartridge may already provide sufficient overpressure to significantly reduce the chance of liquid product emerging via the openings to be pierced in the top sealing film. In an alternative embodiment, the over pressure is applied by inserting gas below the dome member, prior to the top sealing film being pierced. Thus, a gas source and pressure dome adapted to promote the outflow of liquid ingredient can also be used to provide a pressure outside of the top seal prior to it being pierced, and thus reduce the chance of liquid ingredient exiting the cartridge via said openings when the top sealing film is pierced.

Thus the invention also provides a method for providing a beverage, said method comprising, in addition to the standard steps for providing a beverage, the steps of providing a pressure outside the top sealing film prior to piercing the top sealing film of the cartridge.

According to a second aspect, the invention provides a system and a sealed disposable cartridge filled with a single serve portion of a liquid ingredient to be combined with a base liquid in the form a carbonated water for the preparation of a liquid product.

The system comprises a dispenser, for providing a flow of carbonated water, and a sealed cartridge, comprising a portion of liquid ingredient to be mixed with the flow of carbonated water.

Sealed cartridges holding liquid ingredient to be combined with a base liquid for the preparation of a liquid product, e.g. a liquid food product suitable for human consumption, e.g. a beverage, are known.

Furthermore, water dispensers for providing carbonated water are also known. Typically, these types of dispensers are configured to carbonate water. Carbonisation of water can for example be achieved by using an in-line carbonator, integrated in the water line through which the water is pumped to the dispensing outlet, followed by flow compensator for stabilizing the mix of water and CO2. Both the carbonator and the flow compensator require a certain section of water line to enable adding the CO2 to the water and to stabilise the mixture of CO2 with water respectively. Thereof, a significant section of the water line in the dispensing apparatus extends through said two components.

According to the invention, the dispensing apparatus comprises a base frame supporting main components of the dispenser, e.g. a carbonator and a holder for supporting a cartridge in a dispensing position. The dispenser furthermore comprises a mobile supported carbonated water feed member, i.e. a water feed member disposed to be moved relative to a cartridge accommodated in the holder, and a mobile supported flow compensator, i.e. a flow compensator that can be moved relative to the carbonator supported by the frame such that the carbonator, or at least a downstream outlet of the carbonator, can move with the carbonated water feed member.

The invention thus allows for a moveably mounted feed member in combination with a short outflow trajectory, i.e. short distance between the outflow of the flow compensator and the discharge opening of the carbonated water feed member.

It has been found that reducing the length of the outflow channel, enhances the CO2 content of the carbonated water when mixed with the liquid ingredient, i.e. when the carbonated water has been mixed with the liquid ingredient and the beverage is ready for consumption.

Therefore, according to a second aspect, the invention provides a system for the preparation of a liquid product, e.g. a liquid food product, e.g. a beverage, which system comprises:

a) a disposable cartridge filled with a single serve portion of a liquid ingredient to be combined with carbonated water for the preparation of a liquid product, e.g. a beverage concentrate to be combined with carbonated water, for the preparation of a beverage, the disposable cartridge comprising:

a cartridge body with a bottom and a top, the body delimiting a reservoir that is filled with a single serve portion of a liquid ingredient, said cartridge body comprising:
an aperture in communication with said reservoir, which aperture is hermetically sealed by a sealing film, e.g. a top sealing film, said sealing film having a portion that covers said reservoir,

b) a dispensing apparatus, e.g. a beverage dispensing apparatus, the apparatus comprising:
a base frame for supporting main components of the dispenser,
a holder, mounted to the base frame, which holder is adapted to accommodate and retain the disposable cartridge at a dispensing location in the apparatus,
a carbonated water feed member, e.g. a lance, disposed at the dispensing location,
a water inlet, e.g. a water source such as a water tank or connection to a water main;
a water line extending from the water inlet to the carbonated water feed member, for transporting water from the water inlet to the feed member;
a water pump for pumping water from water source through the water line;
a CO₂ (carbon dioxide) source;
a carbonator, which carbonator is connected to the CO₂ source and is integrated in the water line, for adding CO₂ from the CO₂ source to the water flowing through the water line;
a flow compensator, which flow compensator is integrated in the water line downstream of the carbonator to stabilize the mixture of CO₂ and water emerging from the carbonator, and
a mobile head, wherein the mobile head is moveably supported by the frame so as to be movable relative to the frame, more in particular relative to the holder, i.e. towards a cartridge supported in the holder, and away from the cartridge; and
an operable displacement device which is adapted to move the mobile head relative to the holder, e.g. up and down relative to the holder; and

wherein:

the carbonator is supported by the frame in a fixed position,

the feed member is mounted in the mobile head such that it when the mobile head is moved by the operable displacement device, the feed member is moved relative to the holder, i.e. towards a cartridge supported in the holder and away from the cartridge, and

the flow compensator is movably supported such that it can be moved relative to the carbonator, preferably can be moved with the carbonated water feed member.

Thus, according to the invention, the flow compensator is mounted such that it can move with the feed member, preferably is mounted on top of the feed member, which allows for a minimal outflow trajectory, i.e. the section of water line from the flow compensator to the actual dispensing opening, e.g. the outlet of the carbonated water feed member.

It has been found that reducing the length of the outflow channel, enhances the CO2 content of the carbonated water when mixed with the liquid ingredient, i.e. when the carbonated water has been mixed with the liquid ingredient and the beverage is ready for consumption.

Furthermore, this configuration allows for the carbonated water feed member to connected with a channel of the cartridge and/or to be used to open the sealed cartridge by moving it towards the cartridge, without significant loss of carbon in the carbonated water.

In an embodiment, the flow compensator is mounted on the head, directly to the carbonated water feed member, such that the mobile head moves the flow compensator and the water feed member in unison relative to the base frame and the carbonator supported by that base frame.

In an alternative embodiment, the flow compensator is pivotably mounted to the frame such a downstream outlet of the flow compensator is able to move with the carbonated water feed member by pivoting of the flow compensator relative to the base frame and the carbonator supported by that base frame. This configuration allows for a compact mobile head since the compensator can be mounted adjacent the head, only a top or connecting tube entering the head. A compact head is beneficial since it facilitates mobile support and movement of the head. In a further embodiment, the movement of the head is driven by the operable displacement device, and the flow compensator is pivoted by the movement of the mobile head. Thus no spate drives are required. In an alternative embodiment, a separate drive is provided to move, more in particular pivot, the flow compensator.

In a further embodiment, the pivot axis about which the flow compensator is pivoted is located closely to the upstream end of the flow compensator. Thus, when the flow compensator is pivoted, the end of the flow compensator located adjacent the mobile head can move follow the mobile head, while movement of the end of the flow compensator located near the carbonator is minimal.

In an alternative embodiment, the flow compensator is movably mounted in the frame, for example is supported by a resilient body, and is connected with flexible hoses to the carbonator at one end and to the carbonated water feed member at another end. The resilient mounting allows the position of the flow compensator to adapt in reaction of movement of the mobile head. In an embodiment, the flow compensator is mounted in a horizontal initial position, and movement of the mobile head from an initial position pulls the carbonator in a slanted position.

In an embodiment, the flow compensator has a longitudinal axis with an inlet end, provided with an inlet for receiving a mix of water and CO2 form the carbonator, at one end and an outlet end, with an outlet for providing a stabilised mix of water and CO2 to the feed member, at an opposite end. In a further embodiment, at least one end of the carbonator is connected via a flexible tube to the carbonator or the flow compensator respectively. In a further embodiment, the carbonator is connected to the carbonator with a flexible tube and is connected to the feed member with a flexible tube. The flexible tubes provide an efficient way for compensating the change of position of the flow compensator with respect to the carbonator and/or the feed member.

In a further embodiment one or both flexible tubes are helical tubes. The helical form enhances the adjustment of the tubes to position changes of the flow compensator. In a further embodiment, the carbonator is supported by these helical tubes, the helical tubes providing a resilient support for the flow compensator. Thus, the flow compensator is movably supported by a spiral tube connecting the flow compensator with the carbonator at one end and with a spiral tube connecting the flow compensator with the feed member at the other end.

In a preferred embodiment, the base frame forms the main part of the dispenser device, and the mobile head is a, compared to the base frame, compact component mounted at the front of the base frame to move relative to a holder also mounted at the front of the base frame. In an embodiment the holder is drawer type holder, comprising one or more seats for each receiving a cartridge, which drawer can be moved relative to the base frame between a dispensing position, in which the contents of the cartridge can be mixed with the carbonated water, and an input/output position, in which the one or more cartridges can be inserted into and removed from the respective one or more seats.

In an embodiment, the carbonated water feed member is a linear conduit having a central axis, and the flow compensator has an outlet in the form of a linear conduit having a central axis, which central axis preferably coincides with a longitudinal axis of an insert of the flow compensator, and the flow compensator outlet conduit and the feed member conduit are connected via a single curved conduit section, and the central axis of the outlet conduit and the central axis of the feed member conduit enclose an angle, which angle preferably is larger than 90 degrees, preferably is between 110 and 170 degrees, for example is 120 degrees. The slanted position of the flow compensator with respect to the vertical allows for a low and compact mobile head. In an embodiment, a significant part, preferably more than half, of the flow compensator extends beyond the mobile head into the base frame.

In an embodiment, the flow compensator has an inlet port, which inlet port is connected to a flexible tube that is part of the carbonator, i.e. is provided with a retention network to collect and regulate the flow of carbonated water in the carbonator, which retention network comprises packing materials, e.g. static helical mixers, raschig rings, etc., which packing materials extends up to the inlet port of the flow compensator. Thus, the distance between carbonator and flow compensator is minimal, while the flexible component of the carbonator allows for the position of the flow compensator to change relative to the carbonator. This embodiment provides an efficient and compact configuration.

In an embodiment, the flow compensator is connected to the feed member via a flexible connection, for example a flexible tube, or is provided with a flexible outlet, to allow for movement, in particular a change of angle, of the flow compensator relative to the feed member due to movement of the mobile head. In a further embodiment, the flexible connection is a tube or conduit type member, which preferably is in a straight, i.e. not bend, position when the mobile head supports the feeding member in a position for dispensing carbonated water. The straight conduit provides a minimal of turbulence in the mix of CO2 and water flowing through the channel, which is beneficial for the CO2 content of the final beverage since turbulence drive CO2 from the water.

In a preferred embodiment, the movement of the carbonated water feed member is used to connect the feed member to a channel in the cartridge and/or to open the sealed cartridge by moving it towards the cartridge, without significant loss of carbon in the carbonated water.

In an embodiment, the mobile head is movable along a linear trajectory, preferably parallel to the vertical, and preferably over a distance between 0,4 and 3 cm, for example is 1 cm. Preferably this distance enables the feed member to engage, preferably connect with, the cartridge and/or provide openings in the sealing film of the cartridge.

In an embodiment, the cartridge further comprises:
a column which has a portion that projects upwards from the bottom, wherein the channel extends through the column from an inlet of the channel at a top end of the column, e.g. said top end being sealed to said sealing film, to a dispensing aperture at the side of the bottom of the cartridge, and
one or more dispensing passages arranged to dispense the liquid ingredient from the reservoir, and

wherein the carbonated water feed member is adapted to connect to said inlet of the channel of the cartridge, and

wherein the feed member is mounted in the mobile head such that it can be moved by the operable displacement device relative to the holder, i.e. towards a cartridge supported in the holder to connect the carbonated water feed member to said inlet of the channel so that carbonated water fed into the channel travels through the channel and exits the channel via the dispensing aperture, and away from the cartridge to disconnect the carbonated feed member from said inlet of the channel.

According to the invention, the carbonated water feed member, e.g. a lance, is adapted to connect to an inlet of the channel of the cartridge. Furthermore, the feed assembly is disposed so as to be movable relative to the holder, i.e. towards a cartridge supported in the holder to connect the carbonated water feed member to said inlet of the channel, and away from the cartridge to disconnect the carbonated feed member from said inlet of the channel. Preferably, the movement of the feed assembly is also used to open at least the top sealing film of the cartridge. In a preferred embodiment, the feed assembly, more in particular the feed member, is configured to push down the inlet of the channel of the cartridge and thus open the sealing film.

To ensure product quality, the product cartridge holding the liquid ingredient is hermitically sealed with a sealing film. To enable mixture of the carbonated water with the liquid ingredient, at least the seal of the cartridge should be opened to allow the liquid product to flow from the reservoir of the cartridge. In a preferred embodiment, the cartridge is provided with dispensing channels in its bottom part, which can be sealed prior to dispensing as well, via which channels the liquid flows from the cartridge to be mixed with the carbonated water.

The seal at the top end of the cartridge is pierced to allow gas to enter the reservoir, to thus enable the outflow of the liquid ingredient via the discharge channels at the bottom end of the cartridge. In a preferred embodiment, pressurized gas is used to promote the outflow of liquid product in a controlled manner.

According to a third aspect, the invention provides a system and a sealed disposable cartridge filled with a single serve portion of a liquid ingredient to be combined with a base liquid in the form a carbonated water for the preparation of a liquid product.

Sealed cartridges holding liquid ingredient to be combined with a base liquid for the preparation of a liquid product, e.g. a liquid food product suitable for human consumption, e.g. a beverage, are known.

Water dispensers for providing carbonated water are also known. To ensure product quality, the product cartridge holding the liquid ingredient is hermitically sealed with a sealing film. To enable mixture of the base liquid with the liquid ingredient, the cartridge needs to be opened. At least the seal of the cartridge should be opened to allow the liquid product to flow from the reservoir of the cartridge. In a preferred embodiment, the cartridge is provided with dispensing channels in its bottom part, which dispensing channels, more in particular the outlets thereof, can be sealed prior to dispensing as well. Via these dispensing channels the liquid flows from the cartridge to be mixed with the carbonated water.

The seal at the top end of the cartridge has to be opened to allow gas to enter the reservoir, and to thus enable the outflow of the liquid ingredient via the discharge channels at the bottom end of the cartridge. According to the invention, pressurized gas is used to promote the outflow of liquid product in a controlled manner. The use of air pressure has been found to enable a better controlled discharge process compared to for example mechanical enforcement, e.g. a plunger engaging the cartridge and/or its contents.

Furthermore, according to the invention, only a slight overpressure, e.g. 0.1 bar over the environmental pressure is required to enable a controlled outflow of the liquid ingredient from the cartridge.

Therefore, according to a third aspect, the invention provides a system for the preparation of a liquid product, e.g. a liquid food product, e.g. a beverage, which system comprises:

a) a disposable cartridge filled with a single serve portion of a liquid ingredient to be combined with a base liquid for the preparation of a liquid product, e.g. a beverage concentrate to be combined with water, e.g. carbonated water, for the preparation of a beverage, the disposable cartridge comprising:

a cartridge body with a bottom and a top, the body delimiting a reservoir that is filled with a single serve portion of a liquid ingredient,

wherein the cartridge body has an aperture in communication with said reservoir, which aperture is hermetically sealed by a sealing film, e.g. a top sealing film, said sealing film having a portion that covers said reservoir,

wherein cartridge body is provided with one or more dispensing passages arranged to dispense the liquid ingredient from the reservoir,

wherein the system is adapted to create one or more openings in said portion of the sealing film that covers the reservoir,

b) a dispensing apparatus, e.g. a beverage dispensing apparatus, the apparatus comprising:
a holder adapted to accommodate and retain the disposable cartridge at a dispensing location in the apparatus,
a feed assembly, the feed assembly comprising a base liquid feed member, e.g. a lance, disposed at the dispensing location,
a pressurized gas source, preferably a pressurized air source, e.g. an air pump, wherein the apparatus is adapted to bring said pressurized gas source in direct communication with the reservoir of the disposable cartridge so as to allow said liquid ingredient therein to be pressurized by said gas thereby assisting the dispensing thereof from the reservoir via said one or more dispensing passages,

Thus, the invention provides a dispenser that utilises pressurised gas for promoting the outflow of content form the cartridge, and a dispenser that allows for a controlled outflow of liquid ingredient from the cartridge by providing a pressure above the environmental pressure, e.g. a pressure between 1,05 and 1,2 bar, for example 1,1 bar, to enable the gas to push the contents of the cartridge out of the cartridge.

In an embodiment, the pressurized gas source is provided in the form of a cylinder, which cylinder is configured to move a volume of air similar to the volume of the single serve portion of a liquid ingredient held in the reservoir of the cartridge, such that a single stroke of the cylinder is sufficient to remove the liquid ingredient from the cartridge. Thus, air can be used for promoting the outflow of liquid ingredient, and no pressurised gas source is required to provide the dispenser with pressurised gas.

In an embodiment, the dispensing apparatus is adapted to provide carbonated beverages, the dispensing apparatus comprising:
a water inlet, e.g. a water source such as a water tank or connection to a water main;
a water line extending from water source to the base liquid feed member, for transporting water from the water source to the feed member;
a water pump for pumping water from water source through the water line;
a CO₂ source;
a carbonator, which carbonator is connected to the CO₂ source and is integrated in the water line, for adding CO₂ from the CO₂ source to the water flowing through the water line;
a flow compensator, which is integrated in the water line downstream of the carbonator to stabilize the mixture of CO₂ and water emerging from the carbonator.

In an embodiment according to the invention, the CO₂ source is also the pressurized gas source. In such an embodiment, the apparatus is adapted to bring said CO₂ source in direct communication with the reservoir of the disposable cartridge so as to allow said liquid ingredient therein to be pressurized by said CO₂ source thereby assisting the dispensing thereof from the reservoir via said one or more dispensing passages. In a further preferred embodiment, the CO₂ source is adapted to simultaneously provide CO2 to the carbonator for providing carbonated water and to the cartridge for promoting the outflow of liquid ingredient from the cartridge.

In an embodiment, the dispenser is adapted to control and preferably adjust the gas pressure and/or the flow rate at which the gas is provided to the cartridge to thus enable better control of outflow of liquid ingredient. Thus, a high initial pressure to promote initial flow can be combined with a gradual decline in pressure as the ingredient flows out. In an embodiment, the dispenser comprises a control system that controls valves and/or pumps and/or a cylinder, etc., to manage the pressure and flow rate. In an embodiment, the dispenser allows the user control of certain parameters regarding the pressure and gas flow.

Thus, the dispenser can be provided with a control system that can be adjusted by a user, e.g. by selecting an option, or that is fully automatic, e.g. is provided with sensors that measure the flow rate of the liquid ingredient expelled from the cartridge.

The invention furthermore provides sealed cartridges adapted to be used in a system according to the invention.

In an embodiment, a cartridge according to the invention is a disposable cartridge filled with a single serve portion of a liquid ingredient to be combined with carbonated water for the preparation of a liquid product, e.g. a beverage concentrate to be combined with carbonated water, for the preparation of a beverage, the disposable cartridge comprising:

a cartridge body with a bottom and a top, the body delimiting a reservoir that is filled with a single serve portion of a liquid ingredient, said cartridge body comprising:
an aperture in communication with said reservoir, which aperture is hermetically sealed by a sealing film, e.g. a top sealing film, said sealing film having a portion that covers said reservoir,
a column which has a portion that projects upwards from the bottom, wherein the channel extends through the column from an inlet of the channel at a top end of the column, e.g. said top end being sealed to said sealing film, to a dispensing aperture at the side of the bottom of the cartridge,
one or more dispensing passages arranged to dispense the liquid ingredient from the reservoir.

In an embodiment, the channel of the cartridge is provided with a turbulence generator, for example with an insert having a rough surface area and/or with one or more protrusions, for example to generate turbulence in the flow of carbonated water passing through the channel and thus promoting the CO2 loss. Such a cartridge can be used for providing low carbonated beverages without the requiring adjustments of the setting of the dispenser, more in particular adjust the amount of CO2 provided by the CO2 source. The invention thus enables a simple dispenser to provide a range of beverages, which differ in the amount of CO2 content. Furthermore, since the turbulence generator is part of the cartridge, it is linked to the content of the cartridge, and there is no risk of wrong settings of the dispenser creating a beverage with a too high or too low CO2 content.

In an embodiment according to the invention the cartridges are provided with one or more piercing members, located in the reservoir of the cartridge, for penetrating the sealing film, which sealing film seals the aperture that provides access to the reservoir, from inside the reservoir, i.e. by pushing the sealing film into the reservoir.

In a preferred embodiment, the piercing members are tapered towards the tip, having an increase in cross section from the tip towards the bottom of the cartridge, at least along the upper part of the spikes. This provides the piercing member with a sharp tip, having optimal piercing properties, which also facilitates aligning openings in the droplet capture member with the tips of the piercing members, i.e. positioning the openings such that the tip associated with the opening is located within the contour of the opening. Furthermore, the tapered configuration enables the droplet capture member to be fit tightly around the piercing member by pushing the droplet capture member into the reservoir, i.e. along the piercing member.

In an embodiment, the piercing members, at least along a top section thereof, are provided with one or more sharp vertical edges, to enable the piercing member to cut into the sealing film and/or droplet capture member while piercing it.

The different aspects of the invention disclosed herein are preferably combined with an in line carbonator as disclosed in US2011268845, US2013171297 and US2014284822, and/or with a flow compensator as disclosed in patent publication US2014239519 and/or with a dispenser as disclosed in US20140239521, PCT/US15/61123 and PCT/US15/61126 and/or with a cartridge as disclosed in PCT/US15/61123 and PCT/US15/61126, which are all enclosed herein by reference.

Advantageous embodiments of the system and cartridge according to the invention are disclosed in the subclaims and in the description, in which the invention is further illustrated and elucidated on the basis of a number of exemplary embodiments, of which some are shown in the schematic drawing.

### BRIEF DESCRIPTION OF THE DRAWINGS

In the drawings

FIG. 1a-b show a top view of a first embodiment of a droplet capture member and of a sealing film according to the invention;

FIG. 2a-b show a top view of a second embodiment of a droplet capture member and of a sealing film according to the invention;

FIG. 3a-b show a top view of a third embodiment of a droplet capture member and of a sealing film according to the invention;

FIG. 4a-b show a top view of a fourth embodiment of a droplet capture member and of a sealing film according to the invention;

FIG. 5a-c show a top view of a fifth embodiment of a droplet capture member and of a sealing film according to the invention;

FIG. 6a-c show a top view of a sixth embodiment of a droplet capture member and of a sealing film according to the invention;

FIG. 7 shows a perspective side view in cross section of a cartridge according to the invention without a sealing film;

FIG. 8 shows a perspective top view of the cartridge of FIG. 7 with a pierced sealing film;

FIG. 9 shows a perspective side view in close up of a bottom section of the cartridge of FIG. 7 with a bottom seal;

FIG. 10 shows a perspective side view in close up of a bottom section of the cartridge of FIG. 7 in a dispensing position without a bottom seal;

FIG. 11 shows a schematic side view in cross section of a cartridge according to the invention;

FIG. 12 shows a schematic top view of a cartridge according to the invention;

FIG. 13 shows a schematic side view in cross section of a dispenser according to the invention with a mobile head in a first working position;

FIG. 14 shows a schematic side view in cross section of the dispenser of FIG. 13 with the mobile head in a second working position;

FIG. 15a-b show a detailed side view in cross section of an exemplary embodiment of an in line flow compensator of the dispenser of FIG. 13; and

FIG. 16a-b show a detailed rear view and a detailed side view in cross section of an exemplary embodiment of a carbonator of the dispenser of FIG. 13.

### DETAILED DESCRIPTION

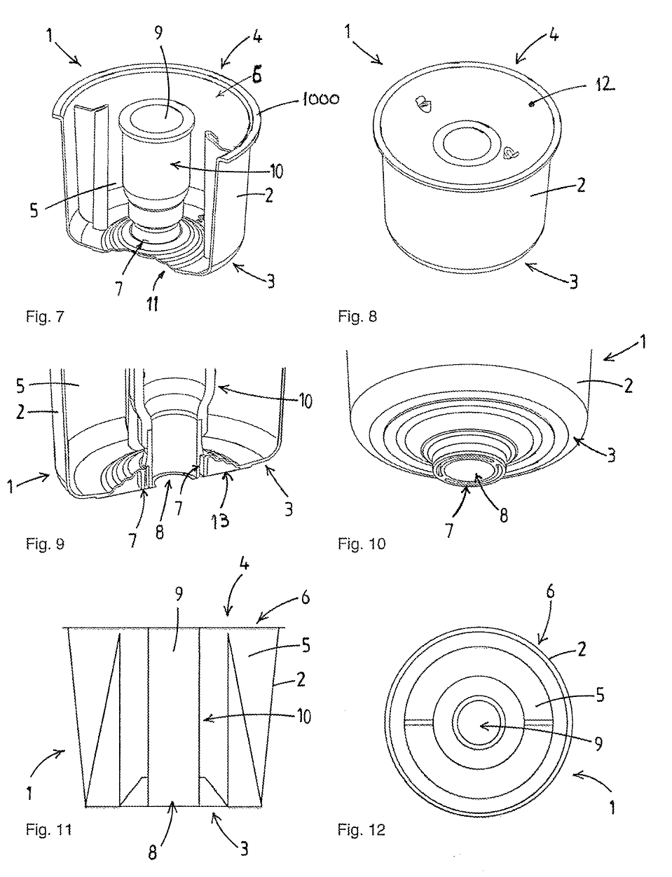

FIG. 1-6 show different combinations of droplet capture members with sealing films for sealing a disposable cartridge according to the invention. Embodiments of such a cartridge are shown in FIGS. 7-10, in which different views are depicted of the cartridge. FIGS. 11 and 12 shows a schematic side and top view of a cartridge according to the invention.

The present invention relates to a system and to a disposable cartridge filled with a single serve portion of a liquid ingredient to be combined with a base liquid for the preparation of a liquid product, e.g. a liquid food product suitable for human consumption, e.g. a beverage concentrate to be combined with water, e.g. carbonated water, for the preparation of a beverage.

Sealed cartridges holding liquid ingredient to be combined with a base liquid for the preparation of a liquid product, e.g. a liquid food product suitable for human consumption, e.g. a beverage, are known.

To ensure product quality, the product cartridge holding the liquid ingredient is hermitically sealed with a sealing film. To enable mixture of the base liquid with the liquid ingredient, the cartridge needs to be opened. The sealing film of the cartridge should be opened at least partially to allow the liquid product to flow from the reservoir of the cartridge.

In a preferred embodiment according to the invention, the liquid ingredient is expelled via openings at the bottom end of the cartridge, and not via openings created in the sealing film. Thus, the liquid ingredient, when being dispensed, flows out of the reservoir, into the openings, e.g. into channels provided in the bottom section of the cartridge, and out of the cartridge at a bottom side thereof.

FIGS. 7-10 show different views of an embodiment of a cartridge according to the invention. FIGS. 11 and 12 shows a schematic side and top view of a cartridge according to the invention.

According to the first aspect, the invention provides a system for the preparation of a liquid product, e.g. a liquid food product, e.g. a beverage, which system comprises a disposable cartridge 1 filled with a single serve portion of a liquid ingredient to be combined with a base liquid for the preparation of a liquid product, e.g. a beverage concentrate to be combined with water, e.g. carbonated water, for the preparation of a beverage.

The disposable cartridge 1 comprises a cartridge body 2 with a bottom 3 and a top 4, the body delimiting a reservoir 5 that is filled with a single serve portion of a liquid ingredient. The cartridge body 2 has an aperture 6 at its top 4, which aperture 6 is in communication with the reservoir 5. In the embodiment shown, the cartridge has multiple dispensing passages 7 located at its bottom 3, which are not shown in FIGS. 11 and 12 but are depicted in FIGS. 7-10.

The one or more dispensing passages 7 are arranged to dispense the liquid ingredient from the reservoir. In the exemplary embodiment shown in FIGS. 7-12, the openings of the dispensing passages 7 are provided around an outlet 8 of a channel 9 located in a column 10 at the centre of the reservoir 5. The column 10 is supported by a flexible bottom portion 11 of the cartridge, which flexible bottom portion allows the column 10 to be moved from an initial raised position, shown in FIGS. 7 and 9, into a lowered dispensing position, shown in FIGS. 8 and 10. In the embodiment shown the flexible bottom portion is conically shaped, see FIG. 9, which conically shaped section is folded from an initial upward and inward directed position, shown in FIG. 9, into an outward and downward directed position, shown in FIG. 10.

The cartridge 2 is provided with a sealing film 12, e.g. a top sealing film. The top sealing film has a portion that covers the aperture 6. The sealing film 12 is sealed to the top 4 of the cartridge, more in particular to a flange 10 extending around the aperture, such that the reservoir 5 of the cartridge body 2 is hermetically sealed by the sealing film 12.

Furthermore, in the embodiment shown, the cartridge 1 is provided with a bottom sealing film 13, depicted in FIG. 9 (and not depicted in FIG. 10). The bottom sealing film 13 seals off the dispensing passages 7 when the column 10 is in its initial raised position.

In the embodiment shown, the cartridge is configured to create openings in the top sealing film and partially remove the bottom sealing film by moving the column from its raised initial position into its lowered dispensing position.

The cartridge shown in FIGS. 7-12 is provided with two piercing members 14 that are arranged underneath the portion of the sealing film 12 that covers the aperture 6, so that pressing the sealing film 12, or at least a part thereof, inward, e.g. downward, causes the piercing members 14 to engage the sealing film 12 and locally rupture the sealing film, thereby providing openings 15 that allow introduction of gas into the reservoir 5 in order to assist dispensing of said liquid ingredient. FIG. 8 shows the piercing members 14, more in particular the tips of the piercing members, extending through the openings 15 created in the top sealing film.

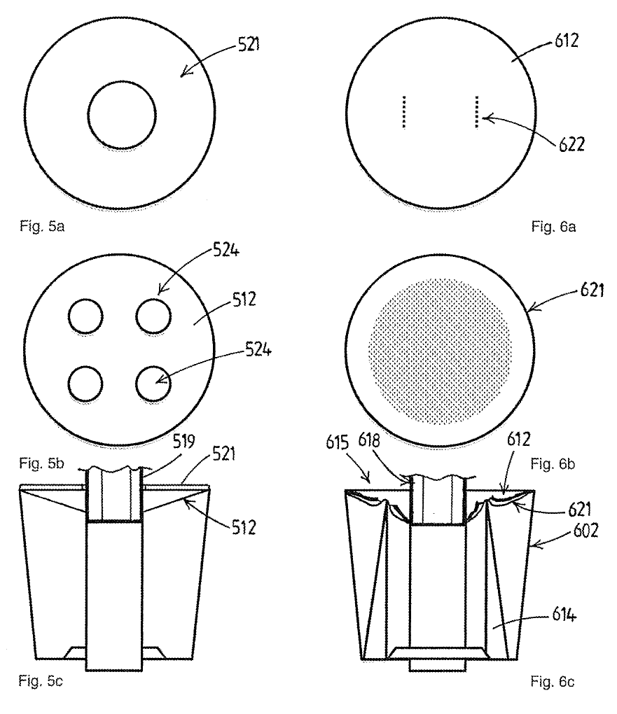

The invention allows for alternative configurations for providing the top sealing film with openings. For example, FIG. 5 shows a cartridge with a top seal adapted to create openings in the top seal without the use of piercing members.

The bottom sealing film is donut shaped, and is sealed along its outer periphery to the bottom of the cartridge and at its inner periphery to the bottom end of the column. In the embodiment shown, the bottom sealing film is removed from the dispensing passages by moving the column downward, into a lowered dispensing position. Due to this movement of the column, the bottom end of the column is forced through the central opening of the bottom sealing film which movement causes the bottom sealing film to peel away from the lower end of the column, which in turn uncovers the openings of the dispensing passages located in the bottom end of the column.

The invention allows for alternative closures of the discharge passages. For example, instead of, or in addition to, using a sealing film, the openings of the discharge passages may be sealed by protrusions located on the bottom part of the cartridge when the column is in its raised position. In an alternative embodiment, the bottom of the cartridge is configured to rupture along the column, when the column is lowered into its dispensing position, to thus provide openings for the liquid ingredient to flow out of the reservoir.

The invention, more in particular droplet capture members as disclosed herein, can be combined with alternative cartridges, for example cartridges as disclosed in PCT/US15/61123 and PCT/US15/61126, to provide a cartridge according to the invention, i.e. a cartridge for providing a system as claimed.

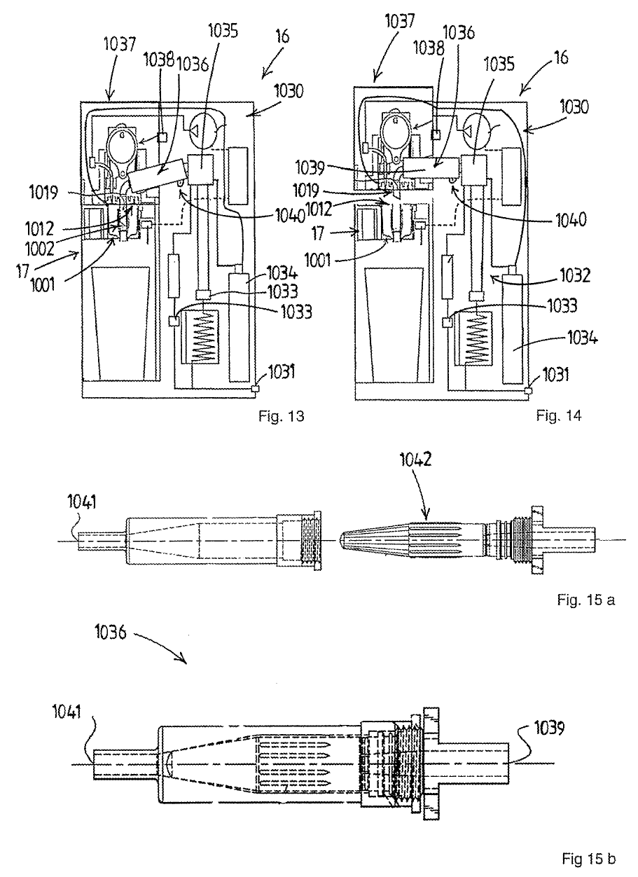

According to the invention, the cartridges are part of a system comprising a dispensing apparatus, e.g. a beverage dispensing apparatus. An exemplary embodiment of such a dispensing apparatus 16 is shown in FIGS. 13 and 14. The apparatus 16 comprises:
a holder 17 adapted to accommodate and retain the disposable cartridge 2 at a dispensing location in the apparatus,
a base liquid feed member 18, e.g. a lance, disposed at the dispensing location, which base liquid feed member is embodied to provide base liquid to be mixed with the liquid ingredient,
a push member 19, configured to engage the top sealing film 12, preferably a central area of the sealing film 12, of the disposable cartridge 2 accommodated in the dispensing location, and to push a portion of said sealing film 12 into the reservoir 5 to rupture the sealing film 12 by means of the one or more piercing members 14 and thus create the one or more openings 15 in the sealing film 12,
an operable displacement device 20 which is adapted to produce a movement of the holder 17 and the push member 19 relative to each other, so that when the displacement device 20 is operated the push member 19 pushes the sealing film 12 into the reservoir, such that the sealing film is ruptured and thus one or more openings in the sealing film are created.

It has been found that a problem may occur with these sealed cartridges when they are opened, in particular when the sealed cartridges are opened by rupture of the top sealing film. Rupture of the top sealing film may cause droplets of liquid ingredient to be propelled from the cartridge and/or seal. These droplets may contact parts of the dispensing device with which the cartridges are used, for example the pushing member for pushing down a column of the cartridge into a dispensing position. This may require cleaning of those parts, which is unwanted.

Therefore, according to the first aspect of the invention, the cartridge is provided with a droplet capture member, which droplet capture member is located adjacent the sealing film and in the vicinity of the piercing members such that after the sealing film has been ruptured the droplet capture member extends over the one or more openings in the sealing film to capture droplets of liquid ingredient exiting said openings while allowing said introduction of gas into the reservoir via said openings.

Thus, the invention provides a system and a cartridge which reduce the chance of contamination of the dispensing device by droplets of liquid ingredient.

As will be explained herein, the droplet capture member can be provided on the inside of the top sealing film or on the outside. In an alternative embodiment, a droplet capture member can be provided on the inside and on the outside of the sealing film.

In an embodiment, the sealing film and the droplet capture member are part of a single, multi-layer sealing film, which sealing film is applied to the cartridge body in a single production step during the production process. In an alternative embodiment, the droplet capture member is attached to the cartridge, or to the sealing form on top of the cartridge, after the reservoir has been sealed with the sealing film.

FIG. 6 shows a top view of an embodiment of a droplet capture member 621 and of a sealing film 612 according to the invention. FIG. 6a shows the top sealing film 612, FIG. 6b shows the droplet capture member 621 and FIG. 6c shows in a cross sectional side view a cartridge 602, as discussed above, with the top sealing film 612 and the droplet capture member 621 and the column 610 of the cartridge pushed in a lowered dispensing position.

The droplet capture member 621 is located adjacent the sealing film 612 on the inside, i.e. adjacent the side of the sealing film 612 facing the reservoir 605. The top sealing film 612 and droplet capture member 621 are sealed to a flange of the cartridge 602 extending around the aperture 605, and to a top end of the column 610.

The top sealing film 612 is provided with pre made score lines 622, located above the piercing members 614, to propagate rupture of the sealing film 622 and to control the location of those ruptures in the top sealing film.

In the embodiment shown, the droplet capture member 621 is a film seal, e.g. a seal made of a flexible foil sheet material. It is noted that the droplet capture member does not need to hermitically seal the reservoir of the cartridge, as this is the function of the film seal. Therefore, the droplet capture member can be made of a material that is thinner, more flexible and more elastic than the top sealing film.

To provide the top sealing film 612 with openings, the push member, e.g. the base liquid feed member 618, engages the top end of the column 610 and pushes it downward into the dispensing position depicted. The top sealing film is thus moved downward and the droplet capture member moves with the sealing film.

In the embodiment shown, the droplet capture member 621 is highly elastic compared to the sealing film 612, such that when the sealing film is pushed into the reservoir, the droplet capture member is only stretched and is not ruptured, which is depicted in FIG. 6c. In this embodiment, when the top sealing film 612 is pushed into the reservoir 605 by the base liquid feed member 618, the droplet capture member 621 is stretched over the piercing members 614, more or less like a tent, and part of the droplet capture member is pushed through the openings 615 in the sealing film by the tips of the piercing members.

The droplet capture 621 member is provided with multiple pores 623, and thus functions as a microporous membrane. The pores 623 are dimensioned such that they allow gas to pass the droplet capture member but obstruct droplets of liquid ingredient from passing the droplet capture member. In such an embodiment, the membrane's micropores are large enough to allow gas molecules to pass, but are smaller than droplets of liquid product. Search a microporous membrane may comprise more than one billion micropores per cm2. Each one of these micropores is for example 1000 times smaller than a drop of water, so water molecules are too large to pass the membrane. However, when the micropores are also many times, at least 100 times, larger than air molecules, gas can easily pass through the membrane and into the reservoir of the cartridge.

In a further embodiment, instead of or in addition to the pores, the droplet capture member is provided with one or more openings, not being pores, for letting through gas, which openings are located away from the piercing member such that the they do not overlap with the openings in the sealing film, i.e. the openings created by rupture of the sealing film at the pre made score lines.

In yet another embodiment, the droplet capture member, or at least the parts of the droplet capture member overlapping with the (potential) openings in the sealing film, is provided with a network of openings larger than the pores discussed above. Thus, the droplet capture forms a net having a mesh that in theory would allow at least small droplets to pass the droplet capture member. However, it has been found that by choosing an appropriate mesh size, the chance of a droplet passing the mesh is sufficiently reduced, even if the mesh is penetrated by the piercing members and/or partially ruptured by the piercing members.

FIG. 1 shows an alternative embodiment of a droplet capture member 121, shown in FIG. 1a and the associated sealing film 112, shown in FIG. 1b. In the alternative embodiment shown, the droplet capture member 121 is provided with pre-cut openings 124 for receiving the piercing members. The openings 124 are dimensioned such that, when the sealing film 112 is pushed into the reservoir, the piercing members pass through the openings 124 in the droplet capture member 121 and do not pierce and/or rupture the droplet capture member. In such an embodiment, the openings are preferably dimensioned such that they tightly fit the piercing members when the droplet capture member has been pushed into the reservoir of the cartridge.

In an alternative embodiment, the pre-cut openings are dimensioned such that the piercing members do not pierce the droplet capture member but only stretch the droplet capture member. In such an embodiment, the droplet capture member may be configured to closely fit the cross section of the piercing members. For example, when the piercing members are provided with a circular, oval or rectangular cross section, the droplet capture member can be a flexible film seal provided with circular, oval or rectangular openings for receiving the piercing members.

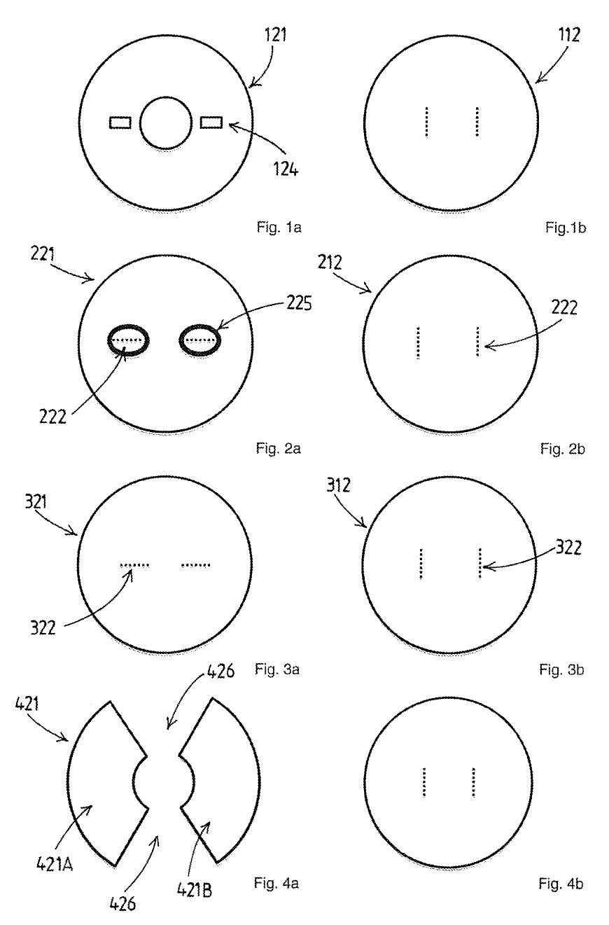

In an embodiment, the droplet capture member is adapted to rupture when pierced by the piercing members. This can be achieved by providing a droplet capture member made of a material that tears easily and/or by providing the droplet capture member with pre made score lines or other local attenuations. The droplet capture members 221, 321 shown in FIGS. 2 and 3 are provided with pre made score lines 222,322 indicated by dotted lines.

It is noted that the most of the exemplary embodiments of droplet capture members are adapted to function with two piercing members. In practice, the droplet capture members can be adapted to function with cartridges comprising a single piercing member, or with cartridges comprising three or more piercing members. For example, by adding or reducing the pre made score lines, or by providing one or more pre made score lines that extend along the entire droplet capture member, and can thus be engaged by a single or multiple piercing members.

The droplet capture member 221 shown in FIG. 2 comprises a thin flexible carrier film, provided with oval shaped reinforcements 225 located such that each encircles an area to be pierced by a piercing member. The local reinforcements 225 prevent significant rupture of the droplet capture member 221 when pierced by the one or more piercing members, to thus ensure that the one or more piercing only create small, local openings, which reduces the chance of any droplets of liquid ingredient passing through them.

In the embodiment shown in FIG. 3, a portion of the sealing film 312 for covering the reservoir is provided premade score lines 322, e.g. by laser machining, which are embodied such that pressing the sealing film 312 into the reservoir causes said one or more premade score lines to rupture thereby providing one or more openings that allow gas to pass the droplet capture member into the reservoir.

The droplet capture member 321 is adapted to be located on the inside of the sealing film 312. A portion of the droplet capture member 321 for covering the reservoir is provided with premade score lines 322, e.g. by laser machining. The score lines 322 in the droplet capture member 321 are embodied such that pressing the sealing film 312 into the reservoir, and thus pushing the droplet capture member 321 into the reservoir, causes said premade score lines 322 in the to rupture thereby providing one or more openings that allow gas to pass the droplet capture member 321 into the reservoir.

In the embodiment shown in FIG. 3, when the sealing film 312 is sealed over the aperture of the cartridge, and thus is placed over the droplet capture member 321, the score lines 322 in the sealing film 321 cross the score lines 322 in the droplet capture member 312, such that rupture of the score lines 322 creates one or more openings in the sealing film and in the droplet capture member, which respective openings only partially overlap.

More in particular, in the embodiment shown, the droplet capture member 321 is provided with premade score 322 lines that extends perpendicular to, and cross with, the premade score 322 lines provided in the sealing film 312. The combination of premade score lines forms an X with the centre of the X located above a piercing member. Thus, when the sealing film 312 is pushed into the reservoir the premade score lines 322 will rupture creating overlapping slid-shaped openings, one slid crossing the other slid. These openings will enable gas to travel from outside the cartridge into the reservoir while hampering a droplet of liquid product, propelled from inside the reservoir due to the rupture of the droplet capture member and/or the sealing film, to escape said reservoir via said openings.

In an alternative embodiment, the droplet capture member is a film type seal provided with premade score lines, which premade score lines are located away from the area that covers the piercing members, such that, when the sealing film is pushed into the reservoir, the rapture of the score lines creates openings in the droplet capture member that do not overlap with the openings in the sealing film.

In an embodiment, the openings in the droplet capture member are dimensioned such that they are cut or torn while the piercing member passes through the openings in the droplet capture member. This may be achieved by providing the openings with a cross section that does not fit the cross section of the piercing member, for example is substantially smaller than the cross section of the piercing member. Preferably, the cuts or ruptures provide the droplet capture member with one or more flaps that rest against the piercing member, and thus at least partially cover the opening in the sealing film located adjacent the droplet capture member. In an embodiment, the piercing members are provided with sharp or jagged edges to promote them cutting into the droplet capture member.

In an embodiment, the openings in foil are dimensioned such that they tightly fit the piercing members, such that the piercing members stretch the foil when passing through the openings, to thus provide tight fit of the droplet capture member around the piercing members. In such an embodiment, the droplet capture member is preferably provided with additional openings, located away from the piercing members such that they do not overlap with any of the openings in the film seal, for facilitating gas to enter the reservoir.

In this context it is mentioned that the droplet piercing member, in particular when made of a thin flexible foil material, when provided with pre-cut openings or even when pierced may fit the piercing members tight enough to prevent droplets of liquid from escaping the reservoir, but not tight enough to prevent gas from escaping the reservoir.

In an embodiment, the droplet capture member is adapted to be cut by the piercing members, and not rupture, such that the piercing members do not create openings that extend substantially beyond the cross section of the piercing members. It is submitted that cutting the droplet capture member allows for a more precise control over the size of the opening created by the piercing member compared to rupture of the droplet capture member. An alternative that also provides more controlled creation of openings, compared to rupture, is providing the droplet capture member and/or the sealing film with premade score lines.

In the embodiment shown in FIG. 4, the droplet capture member 421 is provided in the form of a two-part sealing film, the two parts 421A, 421B of the sealing film defining two openings 426 between them. The sealing film 412 is provided with pre made score lines 422, which result in openings located above the two parts 421A and 421B of the droplet capture member 421.

The droplet capture member 421 is highly elastic compared to the sealing film 412, such that when the sealing film is pushed into the reservoir, the droplet capture member is stretched when engaged by the one or more piercing members, and is pushed by the piercing members through the openings in the sealing film.

It is submitted that when the sealing film 412 has been pierced and the droplet capture member 421 has been passed through the openings in the sealing member, the droplet capture member does not seal those openings. Instead, one or more gaps or channels have been created between the droplet capture member and the sealing film, extending form the openings defined between the two parts of the droplet capture member to the openings pierced in the sealing film. These gaps or channels are wide enough to allow gas to travel between the droplet capture member and the sealing film, and thus to travel through said gaps or channels from the opening in the sealing film to the opening sin the droplet capture member.

However, the gaps or channels are narrow enough to slow down and even stop droplets of liquid product. Since the openings in the droplet capture member and the sealing film do not overlap, a droplet of liquid products has to pass the gap between the droplet capture member and the sealing film to reach an opening in the sealing film. Thus, providing a pre scoured film type droplet capture member at the inside surface of the sealing film prevents droplets of liquid product to be propelled from the reservoir of the cartridge and out of an opening in the sealing film when set sealing film is pierced by the piercing members.

FIG. 5 shows an embodiment of droplet capture member 521 that is to be located adjacent the sealing film 512 on the outside of the reservoir, i.e. adjacent the side of the sealing film facing away from the reservoir.

It is noted that in principle the droplet capture member, when located on the outside of the sealing film, can be provided with any of the features discussed herein, e.g. can be configured to be pierced by the piercing members and/or be provided with pores, etc. However, the embodiment 521 shown comprises features which cannot be used when the droplet capture member is provided on the inside of the sealing film, as will be explained below

The sealing film 512, depicted in FIG. 5b, is provided with four pre-cut 524 openings. After the sealing film 512 has been ruptured, the intact droplet capture member 521 overlaps with the one or more openings created in the sealing film after it has been pierced.

The droplet capture member 521, depicted in FIG. 5a, is provided with a central opening 527, which opening is dimensioned and located for the push member 519, in the embodiment shown a feed member which is partially depicted, to pass through, enabling the push member 519 to push down the sealing film 512, located below the droplet capture member 521, without pushing down the droplet capture member.

In the particular embodiment shown, the sealing film 512 is provided with pre-cut openings 524, and the sealing film is initially sealed to the inside surface of the droplet capture member to close said openings and hermetically seal the reservoir. When the sealing film 512 is pushed downward, i.e. away from the droplet capture member 521, the sealing film is tom from the droplet capture member and the openings 524 are opened for gas to pass through. This is depicted in FIG. 5c. This configuration can be used with cartridge without piercing members.

In an alternative embodiment, the sealing film 512 is provided with pre made score lines and thus configured to be tom by piercing members. In such an embodiment, the sealing film does not need to be sealed to the bottom surface of the droplet capture member. It is noted that in such an embodiment, the sealing film is pushed away from the droplet capture member and into the reservoir to be pierced by the piercing members. Thus, the droplet capture member does not contact the piercing members and is not ruptured when the sealing film is pushed into the reservoir.

Providing the droplet capture member on the outside of the sealing member allows for a simple droplet capture member, since there is no need to provide the droplet capture member with multiple pre-cut openings, pores, and/or premade score lines. Furthermore, the droplet capture member is not contacted by the piercing members when piercing the sealing film, and the droplet capture member will not be transformed during the piercing process. Thus in such an embodiment the droplet capture member can be provided in the form of a donut shaped disc made of foam material, plastic sheet material or even cardboard.

Also, such a droplet capture member may not require as secure an attachment to the cartridge as the top sealing film does. Thus, the droplet capture member may be attached to the sealing film and/or cartridge by local sealing areas, instead of a sealing around the entire circumference of the aperture, or may even be provided with one or more click fingers that grip around the flange of the cartridge to mount the droplet capture member onto the cartridge and sealing film.

An additional benefit of this embodiment is that the droplet capture member covers the tops of the piercing members after the sealing film has been pierced. Thus, when the cartridge is removed from the dispensing device, it shields the tops of the piercing members and prevents accidental contact between those piercing members and the user removing the cartridge.

In an embodiment, the droplet capture member is made of a cardboard, or of foam material. Furthermore, when the droplet capture member is provided on top of the sealing film it can be used as a carrier for print, for example graphics, and can thus be used as a label. Thus, standard cartridges can be provided with a label, located on top of the sealing film, which label also functions as the droplet capture member. Integrating label and droplet catcher member in a single product allows for a simplified production process.

According to a second aspect, the invention provides a system and a sealed disposable cartridge filled with a single serve portion of a liquid ingredient to be combined with a base liquid in the form a carbonated water for the preparation of a liquid product.

FIG. 13 shows a schematic side view in cross section of a dispensing apparatus 16 according to the invention with a mobile head in a first working position, and FIG. 14 shows a schematic side view in cross section of the dispensing apparatus 16 of FIG. 13 with the mobile head in a second working position.

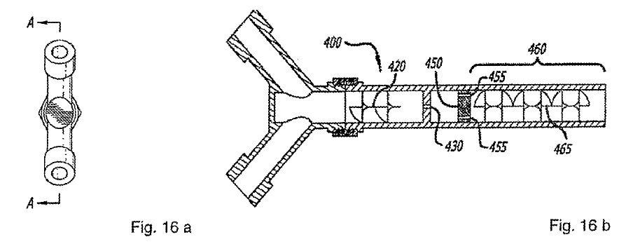

FIG. 15 shows a detailed side view in cross section of an exemplary embodiment of an in line flow compensator of the dispensing apparatus of FIG. 13, and FIG. 16 shows a detailed rear view and a detailed side view in cross section of an exemplary embodiment of a carbonator of the dispensing apparatus of FIG. 13.

According to a second aspect, the invention provides a system for the preparation of a liquid product, e.g. a liquid food product, e.g. a beverage, which system comprises:

a) a disposable cartridge 1001 filled with a single serve portion of a liquid ingredient to be combined with carbonated water for the preparation of a liquid product, e.g. a beverage concentrate to be combined with carbonated water, for the preparation of a beverage, the disposable cartridge comprising:

a cartridge body 1002 with a bottom and a top, the body delimiting a reservoir that is filled with a single serve portion of a liquid ingredient, said cartridge body comprising:
an aperture in communication with said reservoir, which aperture is hermetically sealed by a sealing film 1012, e.g. a top sealing film, said sealing film having a portion that covers said reservoir,

b) a dispensing apparatus 16, e.g. a beverage dispensing apparatus, the apparatus comprising:
a base frame 1030 for supporting main components of the dispenser 16,
a holder 17, mounted to the base frame 1030, which holder 17 is adapted to accommodate and retain the disposable cartridge 1001 at a dispensing location in the apparatus 16,
a carbonated water feed member 1019, e.g. a lance, disposed at the dispensing location,
a water inlet 1031, e.g. a water source such as a water tank or connection to a water main;
a water line 1032 extending from the water inlet to the carbonated water feed member 1019, for transporting water from the water inlet to the feed member;
a water pump 1033, in the particular embodiment shown two pumps, for pumping water from water source through the water line 1032;
a CO₂ source 1034;
a carbonator 1035, i.e. a so called in line carbonator, which carbonator is connected to the CO₂ source and is integrated in the water line 1032, for adding CO₂ from the CO₂ source to the water flowing through the water line;
a flow compensator 1036, which flow compensator 1036 is integrated in the water line 1032, downstream of the carbonator 1035 to stabilize the mixture of CO₂ and water emerging from the carbonator, and
a mobile head 1037, wherein the mobile head is moveably supported by the frame so as to be movable relative to the frame, more in particular relative to the holder 17, i.e. towards a cartridge 1001 supported in the holder 17, and away from the cartridge 1001; and
an operable displacement device 1038 which is adapted to move the mobile head 1037 relative to the holder 17, e.g. up and down relative to the holder; and

wherein:

the carbonator 1035 is supported by the base frame 1030 in a fixed position,

the feed member 1019 is mounted in the mobile head 1037 such that it when the mobile head 1037 is moved by the operable displacement device 1038, the feed member 1019 is moved relative to the holder 17, i.e. towards a cartridge 1001 supported in the holder and away from the cartridge 1001, and

the flow compensator 1036 is movably supported such that it can be moved relative to the carbonator 1035, preferably can be moved with the carbonated water feed member 1019.

In the embodiment shown, the operable displacement device is provided in the form of a drive, adapted to move the mobile head 1037 between a lowered position, shown in FIG. 13, and a raised position, shown in FIG. 14. In an alternative embodiment, the displacement device is adapted to enable a user to move the mobile head by hand.

In the raised position, the mobile head 1037 engages the top of the cartridge 1001 accommodated in the holder 17. In the raised position, the mobile head 1037, more in particular the feed member 1019 supported by the mobile head, dis disengaged from the cartridge accommodated in the holder, which allows for the cartridge to be replaced by another cartridge. In an embodiment, the holder is configured as a drawer type holder, which can slide between a dispensing position, shown in FIGS. 13 and 14, and a replacement position, not shown, that enables the cartridge to be lifted form the holder by hand. Alternative configurations are also possible.

In the embodiment shown, the flow compensator 1036 is pivotably mounted to the base frame 1030 such that a downstream outlet 1039 of the flow compensator is able to move with the carbonated water feed member 1019 by pivoting of the flow compensator relative to the base frame 1030 and the carbonator supported by that base frame. This configuration allows for a compact mobile head since the flow compensator 1036 can be mounted adjacent the mobile head 1037, only a tip of the flow compensator and/or connecting tube entering the mobile head. A compact mobile head is beneficial since it facilitates mobile support and movement of the head. Furthermore, in the embodiment shown, the movement of the mobile head 1037 is driven by the operable displacement device 1038, and the flow compensator 1036 is pivoted by the movement of the mobile head 1037. Thus no separate drives are required. In an alternative embodiment, a separate drive is provided to move, more in particular pivot, the flow compensator.

In a further embodiment, the pivot axis 1040, about which the flow compensator 1036 is pivoted is located closely to the upstream end of the flow compensator. Thus, when the flow compensator 1036 is pivoted, the end of the flow compensator located adjacent the mobile head can follow the mobile head 1037, while movement of the end of the flow compensator 1036 located near the carbonator 1036 is minimal. Connection between the flow carbonator and an upstream inlet 1041 is for example provide by a flexible tube.

Thus, according to the invention, the flow compensator 1036 is mounted such that it can move with the feed member 10119, which allows for a minimal outflow trajectory, i.e. the section of water line from the flow compensator to the actual dispensing opening, e.g. the outlet of the carbonated water feed member.

It has been found that reducing the length of the outflow channel, enhances the CO2 content of the carbonated water when mixed with the liquid ingredient, i.e. when the carbonated water has been mixed with the liquid ingredient and the beverage is ready for consumption.

Furthermore, the configuration shown allows for the carbonated water feed member 1019 to connect with a channel of the cartridge 1001 and to be used to open the sealed cartridge 1001 by moving the feed member 1019 towards the cartridge, thus pressing down the column of the cartridge, as explained above, without significant loss of carbon in the carbonated water.

In an alternative embodiment, the flow compensator 1036 is mounted on the mobile head 1037, preferably directly to the carbonated water feed member 1019, such that the mobile head 1037 moves the flow compensator 1036 and the water feed member 1019 in unison relative to the base frame and the carbonator supported by that base frame. thus, in such an embodiment, the position of the flow compensator relative to the feed member does not change due to movement of the mobile head, i.e. the flow compensator is not moved or pivoted relative to the feed member.

In an alternative embodiment, the flow compensator is movably mounted in the frame, for example is supported by a resilient body, and is connected with flexible hoses to the carbonator at one end and to the carbonated water feed member at another end. The resilient mounting allows the position of the flow compensator to adapt in reaction of movement of the mobile head. In an embodiment, the flow compensator is mounted in a horizontal initial position, and movement of the mobile head from an initial position pulls the carbonator in a slanted position.

In an embodiment, the flow compensator has a longitudinal axis with an inlet end, provided with an inlet for receiving a mix of water and CO2 form the carbonator, at one end and an outlet end, with an outlet for providing a stabilised mix of water and CO2 to the feed member, at an opposite end. In a further embodiment, at least one end of the carbonator is connected via a flexible tube to the carbonator or the flow compensator respectively. In a further embodiment, the carbonator is connected to the carbonator with a flexible tube and is connected to the feed member with a flexible tube. The flexible tubes provide an efficient way for compensating the change of position of the flow compensator with respect to the carbonator and/or the feed member.

In a further embodiment one or both flexible tubes are helical tubes. The helical form enhances the adjustment of the tubes to position changes of the flow compensator. In a further embodiment, the carbonator is supported by these helical tubes, the helical tubes providing a resilient support for the flow compensator. Thus, the flow compensator is movably supported by a spiral tube connecting the flow compensator with the carbonator at one end and with a spiral tube connecting the flow compensator with the feed member at the other end.

In the embodiment shown, the base frame 1030 forms the main part of the dispenser device 16, and the mobile head 1037 is a, compared to the base frame 1030, compact component mounted at the front of the base frame to move relative to the holder 17, which is also mounted at the front of the base frame 1030. In the particular embodiment shown, the holder 17 is drawer type holder, comprising a seats for receiving the cartridge 1001. The which drawer can be moved relative to the base frame between a dispensing position, in which the contents of the cartridge can be mixed with the carbonated water, and an input/output position, in which the one or more cartridges can be inserted into and removed from the respective one or more seats.

In the embodiment show in FIG. 15, the carbonated water feed member 1019 is a linear conduit having a central axis, and the flow compensator 1036 has an outlet 1039 in the form of a linear conduit having a central axis, which central axis coincides with a longitudinal axis of an insert 1042 of the flow compensator. The flow compensator outlet conduit 1039 and the feed member conduit 1019 are connected via a single curved conduit section, and the central axis of the outlet conduit and the central axis of the feed member conduit enclose an angle, which angle is larger than 90 degrees, preferably is between 110 and 170 degrees, for example is 120 degrees, when the mobile head is in the lowered dispensing position.

Furthermore, in the embodiment shown the flow compensator 1036 has an inlet port 1041, which inlet port 1041 is connected to a flexible tube that is part of the in line carbonator 1035, i.e. is provided with a retention network to collect and regulate the flow of carbonated water in the carbonator, which retention network comprises packing materials, e.g. static helical mixers, raschig rings, etc, which packing materials extends up to the inlet port of the flow compensator. It is noted that in the figs, only part of the connecting flexible tube is shown, due to the carbonator be depicted in a highly schematic way. FIG. 16 shows an inline carbonator which can be used with a dispenser according to the invention in more detail.

Thus, in the embodiment shown, the distance between carbonator and flow compensator is minimal, while the flexible component of the carbonator allows for the position of the flow compensator to change relative to the carbonator. This embodiment provides an efficient and compact configuration.

In an embodiment, the flow compensator is connected to the feed member via a flexible connection, for example a flexible tube, or is provided with a flexible outlet, to allow for movement, in particular a change of angle, of the flow compensator relative to the feed member due to movement of the mobile head. In a further embodiment, the flexible connection is a tube or conduit type member, which preferably is in a straight, i.e. not bend, position when the mobile head supports the feeding member in a position for dispensing carbonated water. The straight conduit provides a minimal of turbulence in the mix of CO2 and water flowing through the channel, which is beneficial for the CO2 content of the final beverage since turbulence drive CO2 from the water.

In the embodiment shown in FIGS. 13 and 14, according to a third aspect of the invention, the dispenser 16 utilises pressurised gas for promoting the outflow of content form the cartridge, and a dispenser that allows for a controlled outflow of liquid ingredient from the cartridge by providing a pressure above the environmental pressure, e.g. a pressure between 1,05 and 1,2 bar, for example 1,1 bar, to enable the gas to push the contents of the cartridge out of the cartridge.

In the particular embodiment shown, the CO₂ source 1034 is also the pressurized gas source. The apparatus 16 is adapted to bring said CO₂ source 1034 in direct communication with the reservoir of the disposable cartridge 1001 so as to allow said liquid ingredient therein to be pressurized by said CO₂ source thereby assisting the dispensing thereof from the reservoir via said one or more dispensing passages. Furthermore, the CO₂ source is adapted to simultaneously provide CO2 to the carbonator for providing carbonated water and to the cartridge for promoting the outflow of liquid ingredient from the cartridge. In the particular embodiment shown, a conduit 1042 connects the CO2 source 1034 with a pressure dome, mounted in the mobile head 1037 and configured to engage the top of the cartridge when the mobile head is in the lowered position.

The dispenser comprises a control system, not shown in the Figs., that controls valves and/or pumps and/or a cylinder, etc., to manage the pressure and flow rate of the flow of CO2. Thus, the dispenser 16 is adapted to control and preferably adjust the gas pressure and/or the flow rate at which the gas, in the embodiment shown CO2, is provided to the cartridge to thus enable better control of outflow of liquid ingredient. In an embodiment, the control system enables a high initial pressure to promote initial flow can be combined with a gradual decline in pressure as the ingredient flows out. In an embodiment, the dispenser allows the user control of certain parameters regarding the pressure and gas flow.

In an alternative embodiment, the pressurized gas source is provided in the form of a cylinder, which cylinder is configured to move a volume of air similar to the volume of the single serve portion of a liquid ingredient held in the reservoir of the cartridge, such that a single stroke of the cylinder is sufficient to remove the liquid ingredient from the cartridge. Thus, air can be used for promoting the outflow of liquid ingredient, and no pressurised gas source is required to provide the dispenser with pressurised gas.

1. System for the preparation of liquid food product which system comprises:
a) a disposable cartridge filled with a single serve portion of a liquid ingredient to be combined with a base liquid for the preparation of the liquid food product, the disposable cartridge comprising:
a cartridge body with a bottom and a top, the body delimiting a reservoir that is filled with a single serve portion of a liquid ingredient,
wherein the cartridge body has an aperture at its top, which aperture is in communication with said reservoir, and has one or more dispensing passages located at its bottom, which one or more dispensing passages are arranged to dispense the liquid ingredient from the reservoir;
a sealing film, said sealing film having a portion that covers said aperture, which sealing film is sealed to the cartridge such that the reservoir of the cartridge body is hermetically sealed by said sealing film; and
one or more piercing members that are arranged underneath the portion of the sealing film that covers the aperture, so that pressing the sealing film, or at least a part thereof, inward, causes said one or more piercing members to engage the sealing film and locally rupture the sealing film, thereby providing one or more openings that allow introduction of gas into the reservoir in order to assist dispensing of said liquid ingredient;
b) a dispensing apparatus, the apparatus comprising:
a holder adapted to accommodate and retain the disposable cartridge at a dispensing location in the apparatus,
a base liquid feed member, disposed at the dispensing location, which base liquid feed member is embodied to provide base liquid to be mixed with the liquid ingredient,
a push member, configured to engage the sealing film of the disposable cartridge accommodated in the dispensing location, and to push a portion of said sealing film into the reservoir to rupture the sealing film by means of the one or more piercing members and thus create the one or more openings in the sealing film, and
an operable displacement device which is adapted to produce a movement of the holder for the cartridge and the push member relative to each other, so that when the displacement device is operated the push member pushes the sealing film into the reservoir, ruptures the sealing film and thus creates the one or more openings in the sealing film;
wherein the cartridge is furthermore provided with a droplet capture member, which droplet capture member is located adjacent the sealing film and in the vicinity of the piercing members such that after the sealing film has been ruptured the droplet capture member extends over the one or more openings in the sealing film to capture droplets of liquid ingredient exiting said openings while allowing said introduction of gas into the reservoir via said openings.

2-3. (canceled)

4. System according to claim 1, wherein the droplet capture member is a seal made of a flexible foil sheet material, and is adapted to rupture when pierced by the piercing members.

5. System according to claim 2, wherein the droplet capture member is provided with local reinforcements that prevent significant rupture of the droplet capture member when pierced by the one or more piercing members, to thus ensure that the one or more piercing members only create small openings, which small openings reduce the chance of any droplets of liquid ingredient passing through them.

6. System according to claim 1, wherein the droplet capture member is provided adjacent the inside surface of the sealing film, and is provided with one or more openings for receiving at least a tip of the one or more piercing members, such that, when the sealing film is pushed into the reservoir, the one or more piercing members do not pierce the droplet capture member but only stretch and/or rupture the droplet capture member.

7-13. (canceled)

14. System according to claim 1, wherein the droplet capture member is provided with multiple pores, which pores are dimensioned such that they allow gas to pass the droplet capture member, even when the droplet capture member is not ruptured, but obstruct droplets of liquid ingredient from passing the droplet capture member.

15. System according to claim 1, wherein a portion of the droplet capture member covering the reservoir is provided with one or more premade score lines, which are embodied such that pressing the scaling film into the reservoir causes said one or more premade score lines to rupture thereby providing one or more openings that allow gas to pass the droplet capture member into the reservoir.

16. System according to claim 1, wherein the droplet capture member is highly elastic compared to the sealing film, such that when the sealing film is pushed into the reservoir, the droplet capture member is only stretched and is not ruptured, and wherein the droplet capture member is provided with multiple pores, which pores are dimensioned such that they allow gas to pass the droplet capture member but obstruct droplets of liquid ingredient from passing the droplet capture member.

17. System according to claim 1, wherein the droplet capture member is a film type seal provided with premade score lines, which premade score lines are located away from the area that covers the piercing members, such that, when the sealing film is pushed into the reservoir, rupture of the score lines creates openings in the droplet capture member that do not overlap with the openings in the sealing film.

18. System according to claim 1, wherein a portion of the sealing film covering the reservoir is provided with one or more premade score lines, which are embodied such that pressing the sealing film into the reservoir causes said one or more premade score lines to rupture thereby providing one or more openings that allow gas to pass the sealing film into the reservoir, and
wherein a portion of the droplet capture member covering the reservoir is provided with one or more premade score lines, which are embodied such that pressing the sealing film into the reservoir causes said one or more premade score lines to rupture thereby providing one or more openings that allow gas to pass the droplet capture member into the reservoir, and
wherein the score lines in the sealing film cross the score lines in the droplet capture member, such that rupture of the score lines creates one or more openings in the sealing film and in the droplet capture member, which respective openings only partially overlap.

19. (canceled)

20. System according to claim 1, wherein the droplet capture member is adapted to be cut by the piercing members, and not rupture, such that the piercing members do not create openings that extend substantially beyond the cross section of the piercing members.

21. System according to claim 1, wherein the droplet capture member is located adjacent the sealing film on the outside of the reservoir, i.e. adjacent the side of the sealing film facing away from the reservoir, and is provided with an opening, which opening is dimensioned and located for the push member to pass through, enabling the push member to push down the sealing film, located below the droplet capture member, without pushing down the droplet capture member, such that the droplet capture member does not contact the piercing members and is not ruptured when the sealing film is pushed into the reservoir.

22. System according to claim 11, wherein the droplet capture member has a stiffness such that it substantially holds its shape when the sealing film is pushed into the reservoir, and the sealing film is thus at least partially pushed away from the droplet capture member, creating a passage between the sealing film and the droplet capture member, when the sealing film is pushed into the reservoir.

23. (canceled)

24. System according to claim 12, wherein the sealing film is provided with pre-cut openings for enabling gas to flow into the reservoir, which pre-cut openings are located in the part of the sealing film that is to be torn away from the droplet capture member, such that the openings are opened by the pushing action of the pushing member.

25. (canceled)

26. System according to claim 11, wherein the droplet capture member is made of a cardboard material or of foam material, and is a carrier for print and thus also functions as a label.

27. System according to claim 1, wherein the sealing film and the droplet capture member are part of a single, multi-layer sealing film, which sealing film is applied to the cartridge body in a single production step during the production process.

28-30. (canceled)

31. System according to claim 1, wherein the cartridge body comprises a column which has a portion that projects upwards from the bottom, wherein the channel extends through the column from an inlet of the channel at a top end of the column, to a dispensing aperture at the side of the bottom of the cartridge, wherein the base liquid feed member is adapted to connect to said inlet of the channel so that base liquid fed into the channel travels through the channel and exits the channel via the dispensing aperture.

32. System according to claim 16, wherein the base liquid feed ember is the push member, so that when the displacement device is operated the base liquid feed member connects to the channel.

33. (canceled)

34. System according to claim 1, wherein the dispensing apparatus further comprises a pressurized gas source, and wherein the apparatus is adapted to bring said pressurized gas source in direct communication with the reservoir of the disposable cartridge via one or more openings in the sealing film, so as to allow said liquid ingredient therein to be pressurized by said gas thereby assisting the dispensing thereof from the reservoir via said one or more dispensing passages.

35. Sealed disposable cartridge filled with a single serve portion of a liquid ingredient to be combined with carbonated water for the preparation of a liquid product for the preparation of a beverage, the disposable cartridge comprising:
a cartridge body with a bottom and a top, the body delimiting a reservoir that is filled with a single serve portion of a liquid ingredient, said cartridge body comprising:
an aperture in communication with said reservoir, which aperture is hermetically sealed by a sealing film, said sealing film having a portion that covers said reservoir,
a column which has a portion that projects upwards from the bottom, wherein the channel extends through the column from an inlet of the channel at a top end of the column to a dispensing aperture at the side of the bottom of the cartridge,
one or more dispensing passages arranged to dispense the liquid ingredient from the reservoir,
wherein a portion of the sealing film covering the reservoir is provided with one or more premade score lines, which are embodied such that pressing the sealing film into the reservoir causes said one or more premade score lines to rupture thereby providing one or more openings that allow gas to pass the droplet capture member into the reservoir, and
wherein the cartridge is furthermore provided with a droplet capture member, which droplet capture member is located adjacent the sealing film such that after the sealing film has been ruptured, the droplet capture member extends over the one or more openings in the sealing film to capture droplets of liquid ingredient exiting said openings while allowing said introduction of gas into the reservoir via said openings.

36. Sealed disposable cartridge filled with a single serve portion of a liquid ingredient to be combined with carbonated water for the preparation of a liquid product for the preparation of a beverage, the disposable cartridge comprising:
a cartridge body with a bottom and a top, the body delimiting a reservoir that is filled with a single serve portion of a liquid ingredient, said cartridge body comprising:
an aperture in communication with said reservoir, which aperture is hermetically sealed by a sealing film, said sealing film having a portion that covers said reservoir,
a column which has a portion that projects upwards from the bottom, wherein the channel extends through the column from an inlet of the channel at a top end of the column to a dispensing aperture at the side of the bottom of the cartridge,
one or more dispensing passages arranged to dispense the liquid ingredient from the reservoir,
one or more piercing members that are arranged underneath the portion of the sealing film that covers the aperture, so that pressing the sealing film, or at least a part thereof, inward causes said one or more piercing members to engage the sealing film and locally rupture the sealing film, thereby providing one or more openings that allow introduction of gas into the reservoir in order to assist dispensing of said liquid ingredient;
wherein the cartridge is furthermore provided with a droplet capture member, which droplet capture member is located adjacent the sealing film and in the vicinity of the piercing members such that after the sealing film has been ruptured, the droplet capture member extends over the one or more openings in the sealing film to capture droplets of liquid ingredient exiting said openings while allowing said introduction of gas into the reservoir via said openings.
